(19) United States
(12) Patent Application Publication
(10) Pub. No.: US 2024/0375284 A1
(43) Pub. Date: Nov. 14, 2024

(54) CALIBRATION DEVICE FOR CALIBRATING MECHANISM ERROR PARAMETER AND DETERMINATION DEVICE FOR DETERMINING NECESSITY OF CALIBRATING MECHANISM ERROR PARAMETER

(71) Applicant: FANUC CORPORATION, Yamanashi (JP)

(72) Inventors: Yuelai WANG, Yamanashi (JP); Yasuhiro NAITOU, Yamanashi (JP); Kunihiko HARADA, Yamanashi (JP)

(21) Appl. No.: 18/686,870

(22) PCT Filed: Sep. 27, 2021
(86) PCT No.: PCT/JP2021/035409

§ 371 Date: Feb. 27, 2024

(51) Int. Cl. B25J 9/16; B25J 13/08

(52) U.S. Cl. CPC B25J 9/1692; B25J 13/089

(57) ABSTRACT

This calibration device comprises a position acquisition unit for acquiring the position of a robot in a reference coordinate system, and a parameter calculation unit for calculating a mechanism error parameter. A first state of the robot and a second state of the robot later than the first state are defined. The parameter calculation unit calculates the mechanism error parameter such that, when the robot is driven by a command value of a movement program, the position of the robot in the reference coordinate system at the time of the second state matches with the position of the robot in the reference coordinate system at the time of the first state.

### RELATED APPLICATIONS

The present application is a National Phase of International Application No. PCT/JP2021/035409 filed Sep. 27, 2021.

### TECHNICAL FIELD

The present invention relates to a calibration apparatus for calibrating mechanism error parameters and a determination apparatus for determining the need for calibrating mechanism error parameters.

### BACKGROUND ART

In the related art, a robot apparatus that includes an operation tool and a robot for moving the operation tool is known. When the robot is driven, various operation can be performed while changing the position and orientation of the operation tool. The position and orientation of the robot are specified in an operation program. In a robot system provided with a plurality of robot apparatuses, a control in which an operation of one robot is controlled so as to follow an operation of an another robot is known (e.g., Japanese Unexamined Patent Publication No. 10-83208A).

Preferably, the position and orientation of the robot matches the position and orientation defined in the operation program. However, after replacing a robot, the robot may not reach the desired position and orientation due to an error in the installation position of the robot and individual differences in robots. It is known that after replacing a robot, the position of the origin of a base coordinate system set at the robot is measured and the positional deviation of the base coordinate system is calculated by a vision sensor. Then, based on the detection result, the operation program for driving the robot is usually modified (e.g., Japanese Patent No. 6603289B and Japanese Unexamined Patent Publication No. 2019-14011A).

### CITATION LIST

### Patent Literature

PTL 1: Japanese Unexamined Patent Publication No. 10-83208A
PTL 2: Japanese Patent No. 6603289B
PTL 3: Japanese Unexamined Patent Publication No. 2019-14011A

### SUMMARY OF INVENTION

### Technical Problem

When a robot is driven based on an operation program, the position and orientation of the robot are affected by the production errors in components during robot production and by gravity when the robot is driven. As a result, the position and orientation of the robot may deviate slightly from the position and orientation specified in the operation program. The production errors in the components include errors in the length of arms between the joint axes and errors in the gear ratio of a reduction gear. Items that cause such errors can be set as mechanism error parameters of the robot, and values can be set for each mechanism error parameter. A controller can accurately control the position and orientation of the robot by driving the robot using the mechanism error parameters.

Immediately after the robot is installed, by adjusting the mechanism error parameters, the robot can be controlled so as to be at a desired position and orientation with respect to the command value of the operation program. However, when the robot is driven for a long period of time, the accuracy of controlling the robot is deteriorated due to abrasion of the components of the robot, etc. For this reason, the robot components such as a motor, a reduction gear, or an arm may be replaced. In this case, it is difficult to match the position reached by the robot after the replacement of the components with the position reached by the robot before the replacement of the components.

Further, when the entire robot is replaced, an error in installation occurs due to deviation from the installation reference of the robot or an inclination of the installation plane. Due to the error in the installation of the robot, a serious error may occur in the position and orientation of the robot. The problem, however, is that it is difficult to match the position reached by the robot after the replacement of the robot with the position reached before the replacement of the robot. In other words, it is difficult to restore the base coordinate system of the robot before the replacement.

The error in the position and the orientation of the robot can be modified by re-teaching the position and the orientation after replacement of the components or robot. The problem, however, is that robot teaching work is time consuming and the productivity of a robot apparatus deteriorates. In addition, the correction of the teaching position of the robot needs to be performed for each operation program. The problem is that the teaching work takes a long time. In addition, when the teaching position of the program is corrected, when there is a teaching point for which the teaching position is not corrected, the accuracy in driving the robot may be reduced, or the robot may interfere with peripheral devices.

### Solution to Problem

A first aspect of the present disclosure is a calibration apparatus configured to calibrate mechanism error parameters for adjusting control of a robot based on an operation program. The calibration apparatus includes a position acquisition unit configured to acquire a position of the robot in a reference coordinate system. The calibration apparatus includes a parameter calculating unit configured to calculate the mechanism error parameters based on the position of the robot in the reference coordinate system. The parameter calculating unit is configured to calculate the mechanism error parameters so that the position of the robot in the reference coordinate system in a second state after a first state matches a position of the robot in the reference coordinate system in the first state, when the robot is driven by a command value of the operation program.

A second aspect of the present disclosure is a determination apparatus configured to determine the need for calibrating mechanism error parameters for adjusting robot control based on an operation program. The determination apparatus includes a position acquisition unit configured to acquire a position of the robot in a reference coordinate system. The determination apparatus includes a maintenance determination unit configured to evaluate the accuracy of the position of the robot with respect to a command value of the operation program. The maintenance determination unit is configured to determine the need for calibrating the mechanism error parameters, based on the position of the robot in the reference coordinate system in a first state and the position of the robot in the current reference coordinate system, when the robot is driven by the command value of the operation program.

### Advantageous Effects of Invention

According to one aspect of the present disclosure, a calibration apparatus that can easily calibrate the mechanism error parameters of a robot, and a determination apparatus that determines the need for calibrating the mechanism error parameters can be provided.

### BRIEF DESCRIPTION OF DRAWINGS

FIG. 1 is a perspective view of a robot system in an embodiment.

FIG. 2 is a perspective view of a robot apparatus, a three-dimensional measuring device, and an auxiliary member, in a first state.

FIG. 3 is a block diagram of a robot apparatus and a three-dimensional measuring device.

FIG. 4 is a flowchart of a first control of a calibration apparatus in an embodiment.

FIG. 5 is a perspective view of a robot apparatus, a three-dimensional measuring device, and an auxiliary member, in a second state.

FIG. 6 is a flowchart of a second control of a calibration apparatus.

FIG. 7 is a perspective view of a robot apparatus, a three-dimensional measuring device, and an auxiliary member, in a first state.

FIG. 8 is a flowchart of a third control of a calibration apparatus.

FIG. 9 is a perspective view of a robot apparatus, a three-dimensional measuring device, and an auxiliary member, in a second state.

FIG. 10 is a flowchart of a fourth control of a calibration apparatus.

FIG. 11 is a flowchart of a control by a maintenance determination unit of a controller.

### DESCRIPTION OF EMBODIMENTS

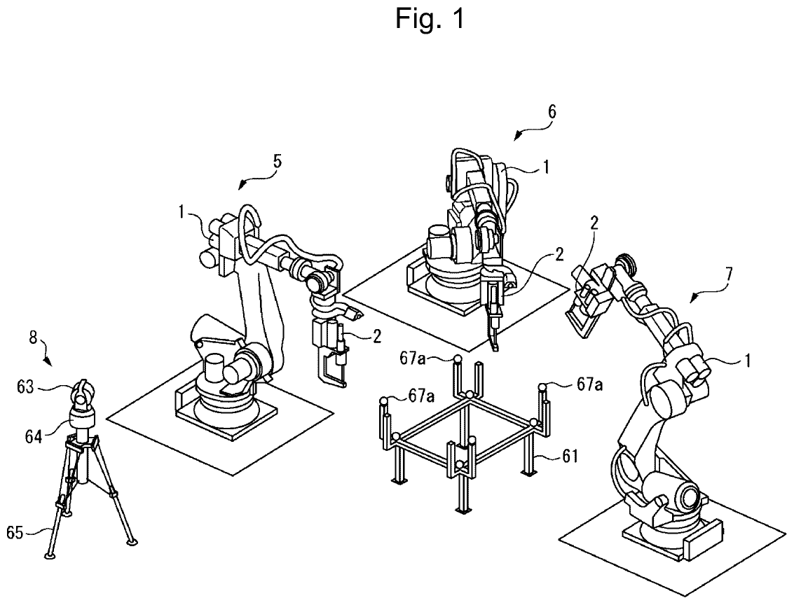

A calibration apparatus and a determination apparatus in an embodiment are described with reference to FIG. 1 to FIG. 11. The calibration apparatus in the present embodiment calibrates mechanism error parameters for adjusting operation of a robot based on an operation program. In addition, the determination apparatus of the present embodiment determines the need for calibrating the mechanism error parameters.

FIG. 1 is a perspective view of a robot system in the present embodiment. The robot system of the present embodiment performs spot welding with three robot apparatuses 5, 6, and 7. Each of the robot apparatuses 5, 6, and 7 is provided with a welding gun 2 as an operation tool and a robot 1 that changes a position and orientation of the welding gun 2. A workpiece for welding is conveyed to a region surrounded by the robot apparatuses 5, 6 and 7. For example, a vehicle body as a workpiece suspended by a conveying machine is conveyed. Spot welding is performed by the robot apparatuses 5, 6, and 7.

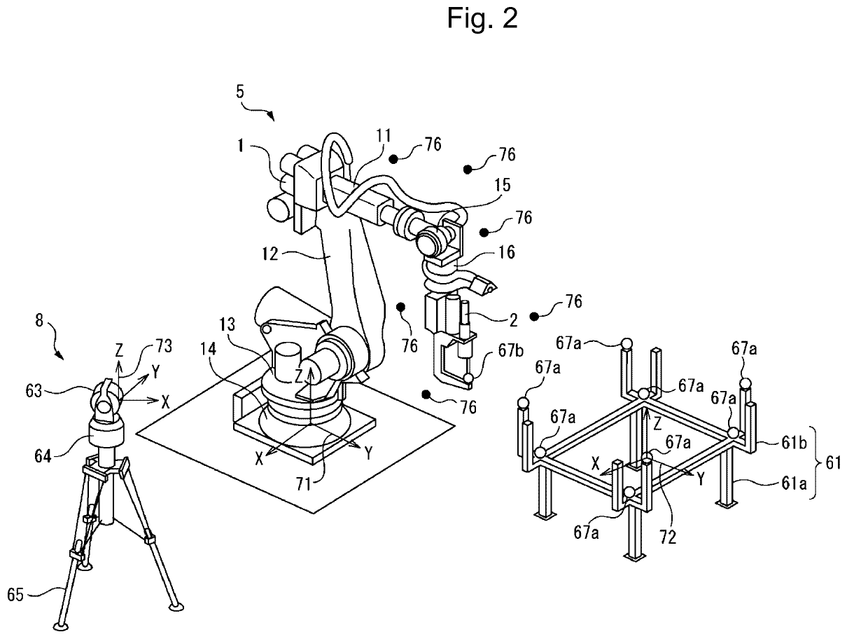

FIG. 2 illustrates a perspective view of a robot apparatus, a three-dimensional measuring device, and an auxiliary member. In this case, of the plurality of robot apparatuses 5, 6, and 7, the robot apparatus 5 is used as an example. The robot apparatuses 6 and 7 have the same configuration as the robot apparatus 5. The robot 1 of the present embodiment is an articulated robot including a plurality of joints.

The robot 1 includes a base part 14 fixed to an installation surface and a swivel base 13 rotatably supported by the base part 14. The robot 1 includes an upper arm 11 and a lower arm 12. The lower arm 12 is supported so as to rotate with respect to the swivel base 13. The upper arm 11 is supported so as to rotate with respect to the lower arm 12. In addition, the upper arm 11 rotates around a rotation axis parallel to a direction in which the upper arm 11 extends. The robot 1 includes a wrist 15 rotatably supported at the upper arm 11. The wrist 15 also includes a flange 16 that is configured to rotate. The welding gun 2 is fixed to the flange 16.

The robot of the present embodiment includes six drive axes, but is not limited to this configuration. A robot that can change its position and orientation by any mechanism can be used. In addition, an operation tool of the present embodiment is a welding gun that performs spot welding, but is not limited to this configuration. The operator can select an appropriate operation tool for the operation to be performed by the robot apparatus. For example, an operation tool for conveying a workpiece or an operation tool for applying an adhesive can be used.

A base coordinate system 71 is set for the robot apparatus 5 in the present embodiment. In the example illustrated in FIG. 2, the origin of the base coordinate system 71 is located at the base part 14 of the robot 1. The base coordinate system 71 is a coordinate system in which the position of the origin is fixed to the robot and the orientations of the coordinate axes are fixed. The position and orientation of the base coordinate system 71 do not change even when the position and orientation of the robot 1 change. The base coordinate system 71 includes X, Y, and Z axes perpendicular to each other as coordinate axes. Additionally, a W-axis is set as a coordinate axis around the X-axis. A P-axis is set as a coordinate axis around the Y-axis. An R-axis is set as a coordinate axis around the Z-axis.

The robot apparatus 5 includes a tool coordinate system with the origin set at any position of the operation tool. In the present embodiment, the origin of the tool coordinate system is set at a tool center point, which is a distal end of a fixed electrode of the welding gun 2. The tool coordinate system is a coordinate system in which the position and orientation change with the operation tool. The position of the robot 1 corresponds to the position of the origin of the tool coordinate system in the base coordinate system 71. The orientation of the tool coordinate system with respect to the base coordinate system 71 corresponds to the orientation of the robot 1. The position and orientation of the robot 1 can be represented by a coordinate value of the base coordinate system 71.

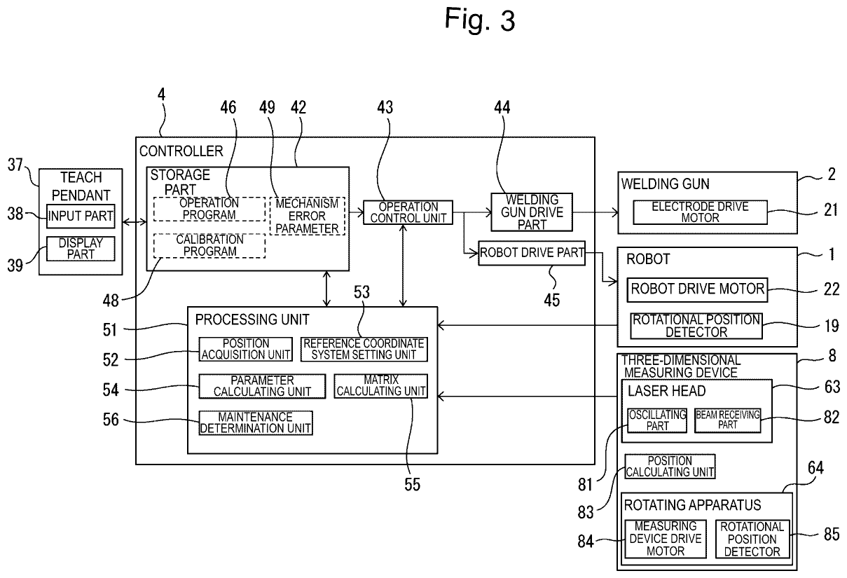

FIG. 3 illustrates a block diagram of the robot apparatus and the three-dimensional measuring device in the present embodiment. Referring to FIG. 2 and FIG. 3, the robot 1 includes a robot drive apparatus that changes the position and orientation of the robot 1. The robot drive apparatus includes robot drive motors 22 that drive components such as the upper arm 11, the lower arm 12, and the wrist 15.

The welding gun 2 is provided with a welding gun drive apparatus that drives the welding gun 2. The welding gun drive apparatus includes an electrode drive motor 21 that drives a movable electrode of the welding gun 2. The movable electrode moves with respect to the fixed electrode by being driven by the electrode drive motor 21. By moving the movable electrode, spot welding can be performed with the workpiece sandwiched between the fixed electrode and the movable electrode.

The robot apparatus 5 includes a controller 4 that controls the robot 1 and the welding gun 2, and a teach pendant 37 on which the operator operates a controller 4. The controller 4 includes an arithmetic processing device (computer) including a Central Processing Unit (CPU) as a processor. The controller 4 includes a Random Access Memory (RAM), a Read Only Memory (ROM), or the like, which are connected to the CPU via a bus.

The teach pendant 37 includes an input part 38 for inputting information related to the robot 1 and the welding gun 2. The input part 38 includes a keyboard, a dial, or the like. The operator can input an operation program, a setting value of a variable, and a determination value of a variable to the controller 4 using the input part 38. The teach pendant 37 includes a display part 39 that displays information related to the robot 1 and the welding gun 2.

An operation program 46 created in advance for controlling the robot 1 and the welding gun 2 is input to the controller 4. Alternatively, teaching points of the robot 1 can be set by the operator operating the teach pendant 37 and driving the robot 1. Based on the teaching points, the controller 4 can generate the operation program 46 for driving the robot 1 and the welding gun 2.

The controller 4 includes a storage part 42 that stores information related to control of the robot 1 and the welding gun 2. The storage part 42 can be configured with a non-temporary storage medium capable of storing information. For example, the storage part 42 can be configured with a storage medium such as a volatile memory, a nonvolatile memory, a magnetic storage medium, or an optical storage medium. The processor functioning as an operation control unit 43 is formed so as to be capable of reading information stored in the storage part 42. The operation program 46 is stored in the storage part 42. The robot apparatus 5 performs the operation automatically based on the operation program 46.

The controller 4 includes the operation control unit 43 that sends an operation command to the robot 1 and the welding gun 2. The operation control unit 43 sends an operation command for driving the robot 1 to a robot drive part 45 based on the operation program 46. The robot drive part 45 includes an electric circuit that drives the robot drive motor 22. The robot drive part 45 supplies electricity to the robot drive motor 22 based on the operation command. In addition, the operation control unit 43 sends an operation command for driving the welding gun 2 to a welding gun drive part 44 based on the operation program 46. The welding gun drive part 44 includes an electric circuit that supplies electricity to an electrode or drives the electrode drive motor 21. The welding gun drive part 44 supplies electricity to the electrode and the electrode drive motor 21 based on the operation command.

The robot 1 includes a state detector for detecting a state of the robot 1, and the state includes a position and orientation of the robot 1. The state detector in the present embodiment includes a rotational position detector 19 attached to the robot drive motor 22 corresponding to a drive axis of a component such as an arm. The rotational position detector 19 is configured with an encoder or the like that detects a rotation angle of the robot drive motor 22. In the present embodiment, the position and orientation of the robot are detected based on the output of a plurality of rotational position detectors 19.

The operation control unit 43 controls the robot 1 so that the robot is at the position and orientation specified in the operation program 46. The operation control unit 43 controls the rotation angle of the robot drive motor 22 based on inverse kinematics. For example, by controlling the robot 1 so that the tool coordinate system is at a desired position and orientation, the operation tool can be controlled to be at the desired position and orientation.

An actual position and orientation of the robot may deviate from the position and orientation specified in the operation program 46 due to production errors in components of the robot, assembly errors in assembling the robot, the effect of gravity, and the like. In the present embodiment, a plurality of mechanism error parameters 49 are set for adjusting control of the robot 1, in addition to the operation program 46. The plurality of mechanism error parameters 49 are stored in the storage part 42.

The mechanism error parameters 49 include any parameters that cause position and orientation errors in driving the robot 1. The mechanism error parameters 49 include parameters such as the length of a link between drive axes, the position of each drive axis, a gear ratio error caused by backlash at the reduction gear of each drive axis, and a variable regarding the elastic deformation of the link that is deformed by the effect of gravity.

For example, the mechanism error parameters include DH parameters and errors in the DH parameters. In the Denavit Hartenberg (DH) method, a coordinate system is set for each drive axis, and the position and orientation of the robot can be expressed based on the relationship between the coordinate systems of the drive axes. The DH parameters are parameters in the DH method. For example, the DH parameters include the link length.

The mechanism error parameters also include a spring constant for the torque around the drive axis. The spring constant is a parameter related to the amount of deflection relative to the torque. The mechanism error parameters also include an error in the gear ratio of the reduction gear. The mechanism error parameters also include an error in the position of the origin of the base coordinate system 71. The error in the position of the origin of the base coordinate system is determined by an error in the rotation angle or pulse value output by the rotational position detector 19. Such mechanism error parameters can be set when the robot 1 is shipped, in response to the location at which the robot 1 is installed.

Referring to FIG. 3, in the operation program 46, the position and orientation of the robot 1 are determined by a coordinate value of the base coordinate system 71. The operation control unit 43 calculates a rotation angle of the robot drive motor 22 so that the robot 1 is at the position and orientation set in the operation program 46 based on reverse kinematics. At this time, the operation control unit 43 acquires the mechanism error parameters 49 stored in the storage part 42. The operation control unit 43 calculates an operation command of the robot drive motor 22 based on each mechanism error parameter. By performing this control, the position and orientation of the robot can be brought closer to the position and orientation specified in the operation program 46.

Referring to FIG. 1 to FIG. 3, the robot system of the present embodiment includes a three-dimensional measuring device 8 for accurately measuring the position and orientation of the robot 1. The three-dimensional measuring device 8 in the present embodiment is a laser tracker that emits laser beam and receives laser beam reflected by reflectors 67a and 67b. The three-dimensional measuring device 8 includes a laser head 63 that emits laser beam. The laser head 63 includes an oscillating part 81 that emits laser beam and a beam receiving part 82 that receives laser beam reflected at the reflectors 67a and 67b. The beam receiving part 82 is located inside the laser head 63.

The three-dimensional measuring device 8 in the present embodiment includes a rotating apparatus 64 that changes the orientation of the laser head 63. The rotating apparatus 64 includes a measuring device drive motor 84 that changes the orientation of the laser head 63. A rotational position detector 85 such as an encoder is attached to the measuring device drive motor 84 in order to detect a rotation angle of the measuring device drive motor 84. The rotating apparatus 64 of the present embodiment rotates the laser head 63 around a rotation axis extending in the horizontal direction and a rotation axis extending in the vertical direction. The rotating apparatus 64 is supported by a tripod 65. Thus, the three-dimensional measuring device 8 can emit laser beam in any direction by being driven by the rotating apparatus 64.

The three-dimensional measuring device 8 includes an arithmetic processing device including a CPU, as a processor, and a RAM. The arithmetic processing device of the three-dimensional measuring device 8 includes a position calculating unit 83 for calculating the positions of the reflectors 67a and 67b. The position calculating unit 83 corresponds to a processor driven according to a predetermined program. The position calculating unit 83 of the present embodiment calculates a distance from the three-dimensional measuring device 8 to the reflectors 67a and 67b by the phase difference between the emitted laser beam and the received laser beam.

A measuring device coordinate system 73 is set for the three-dimensional measuring device 8 in the present embodiment. The measuring device coordinate system 73 can be set at any position by the operator. The origin of the measuring device coordinate system 73 can be set at any position inside the three-dimensional measuring device 8. For example, the origin of the measuring device coordinate system 73 can be located at the distal end of a laser beam source located inside the laser head 63.

The measuring device coordinate system 73 includes coordinate axes with an X, Y, and Z axis perpendicular to each other. The orientation of the measuring device coordinate system 73 can be set to any orientation. The measuring device coordinate system 73 is a coordinate system in which the position of the origin is fixed and the orientations of the coordinate axes are fixed. The position and orientation of the measuring device coordinate system 73 do not change even when the orientation of the laser head 63 changes.

The reflectors 67a and 67b in the present embodiment are spherical in shape. The reflectors 67a and 67b are formed so as to reflect the laser beam in the same direction as the direction of incident laser beam. The reflectors 67a and 67b are fixed at the desired position by means of a restricting band, a magnet, or the like.

The rotating apparatus 64 of the three-dimensional measuring device 8 adjusts the orientation of the laser head 63 so that the laser beam returns to the laser head 63 after being reflected by the reflectors 67a, 67b. The operator can adjust the orientation of the laser head 63 by manually driving the rotating apparatus 64. Alternatively, the three-dimensional measuring device 8 may include an automatic search function for scanning the laser beam so as to exit in a circular pattern. In this case, the operator adjusts the approximate orientation of the laser head 63 so that the laser beam emitted from the three-dimensional measuring device 8 is directed toward the reflectors 67a, 67b. After this, the three-dimensional measuring device 8 can adjust the orientation of the laser head 63 so that the laser beam reflected by the reflectors 67a, 67b returns to the laser head 63 by the automatic search function.

The rotating apparatus 64 can detect the orientation of the laser head 63 in the measuring device coordinate system 73 based on the output of the rotational position detector 85. By receiving the beam reflected by the reflectors 67a and 67b, the position calculating unit 83 calculates the distance from the three-dimensional measuring device 8 to the reflectors 67a and 67b. The position calculating unit 83 can then calculate the position of the reflectors 67a, 67b in the measuring device coordinate system 73 based on the calculated distance and the orientation of the laser head 63.

Referring to FIG. 2 and FIG. 3, a calibration apparatus in the present embodiment calibrates the mechanism error parameters for adjusting control of the robot 1. The calibration apparatus in the present embodiment includes the controller 4. The controller 4 includes a processing unit 51 that performs control for calibration of the mechanism error parameters 49. The processing unit 51 includes a reference coordinate system setting unit 53 that sets a reference coordinate system 72 in the region at which the robot 1 is arranged based on the output of the three-dimensional measuring device 8. The reference coordinate system 72 can be determined so as not to depend on operation of the robot and an installation state of the robot. The installation state of the robot 1 includes a position at which the robot 1 is installed, and the overall inclination of the robot 1 with respect to the surface at which the robot 1 is installed. The reference coordinate system 72 can be set as an immovable coordinate system.

The processing unit 51 includes a position acquisition unit 52 that acquires the position of the robot in the reference coordinate system 72. The processing unit 51 includes a parameter calculating unit 54 that calculates the mechanism error parameters 49 based on the position of the robot in the reference coordinate system 72. The processing unit 51 also includes a matrix calculating unit 55 that calculates a transformation matrix for converting one coordinate value of the coordinate value of the base coordinate system 71 set for the robot 1 and the coordinate value of the reference coordinate system 72 into the other coordinate value. The processing unit 51 includes a maintenance determination unit 56 that evaluates the accuracy of the position of the robot relative to the command value of the operation program 46.

The processing unit 51 performs processing based on a predetermined calibration program 48. The processing unit 51 corresponds to a processor driven according to the calibration program 48. Each unit of the position acquisition unit 52, the reference coordinate system setting unit 53, the parameter calculating unit 54, the matrix calculating unit 55, and the maintenance determination unit 56 corresponds to a processor driven according to the calibration program 48. By performing the control predetermined in the calibration program 48, the processor functions as each unit.

The calibration apparatus of the present embodiment includes an auxiliary member 61 for setting the reference coordinate system 72, and the reflector 67a as a member acting as a reference point. The auxiliary member 61 supports a plurality of reflectors 67a. The auxiliary member 61 is arranged at the region at which the robot system is installed. The auxiliary member 61 can be arranged near the robot 1 that performs calibration. The auxiliary member 61 of the present embodiment includes a base 61a as a platform and an erected part 61b that erects from the base 61a. The erected part 61b extends upward in the vertical direction.

The reflector 67a is arranged at a corner on the top face of the base 61a. In addition, the reflector 67a is arranged at the top face of some erected parts 61b of the plurality of erected parts 61b. Thus, the auxiliary member 61 is formed so as to support the reflectors 67a at a plurality of positions that are different from each other. The auxiliary member 61 is not limited to this form, and a member holding a plurality of reflectors 67a can be used.

The auxiliary member 61 can be a member that does not move at the region where the robot 1 is installed so that the positions of the plurality of reflectors 67a do not change. For example, a shelf or fence installed at the region where the robot system is arranged may be used as an auxiliary member for attaching the reflectors.

When setting the reference coordinate system 72, the position calculating unit 83 of the three-dimensional measuring device 8 calculates the positions of a plurality of reflectors 67a by the measuring device coordinate system 73. The plurality of reflectors 67a to be measured can be predetermined.

The reference coordinate system setting unit 53 of the processing unit 51 sets the reference coordinate system 72 based on the positions of the reflectors 67a. The position of the origin of the reference coordinate system 72 and the orientation of the reference coordinate system 72 can be set at a predetermined relative position and orientation with respect to the measured positions of the plurality of reflectors 67a. In the example here, a reference coordinate system 72 is set with the origin arranged at one reflector 67a.

Thus, based on the position of the reference point measured by the three-dimensional measuring device 8, the reference coordinate system setting unit 53 can set the reference coordinate system 72 in the three-dimensional space. The reference coordinate system setting unit 53 can set the reference coordinate system 72 with the coordinate value of the measuring device coordinate system 73. The reference coordinate system 72 is determined based on the positions of a plurality of reflectors 67a. For this purpose, by maintaining the same positions of the reflectors 67a, the three-dimensional measuring device 8 can measure the positions of the reflectors 67a from any direction. The same reference coordinate system 72 can then be reproduced based on the relative positions and orientations with respect to the plurality of reflectors 67a.

In the present embodiment, a reflector 67b is located at the distal end of the fixed electrode corresponding to the tool center point of the welding gun 2. Thus, the position of the reflector 67b corresponds to the position of the robot 1. The position calculating unit 83 of the three-dimensional measuring device 8 can measure the position of the reflector 67b in the measuring device coordinate system 73. The position acquisition unit 52 can then calculate the position of the robot 1 in the reference coordinate system 72 based on the position of the reflector 67b in the measuring device coordinate system 73.

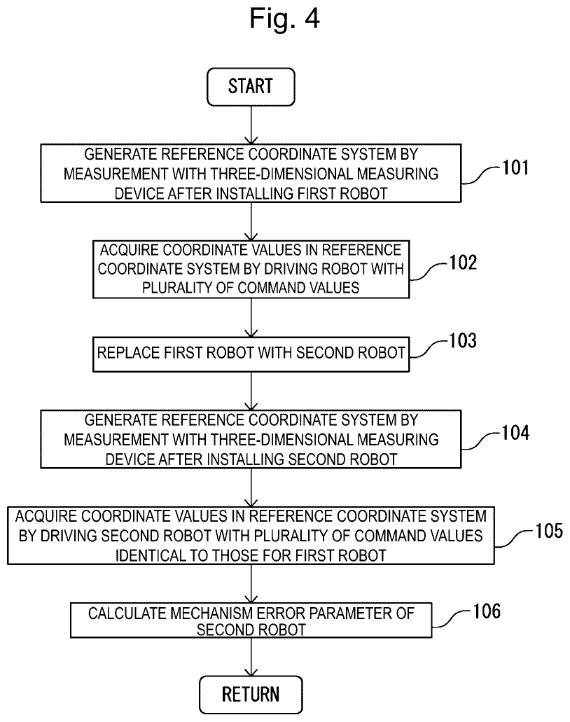

FIG. 4 illustrates a flowchart of a first control for calibrating the mechanism error parameters in the present embodiment. The first control calibrates the mechanism error parameters after replacing the robot 1. When a robot is used for a long period of time, for example, the entire robot may be replaced.

In the present embodiment, a first state of the robot is defined in relation to the calibration of the mechanism error parameters. In the present embodiment, the first state is defined as the reference state of the robot before calibration of the mechanism error parameters. Further, a second state after the first state is defined. The second state includes a state for calibrating the mechanism error parameters or a state for determining whether or not to calibrate the mechanism error parameters.

In the first control, the first state is a state before an old robot is replaced. The second state is a state after the robot is replaced with a new robot. In the present embodiment, the robot before being replaced is referred to as the first robot and the robot after being replaced is referred to as the second robot. In the first control, the first state can be the state immediately before the first robot is replaced. Alternatively, the first state can be a state immediately after the mechanism error parameters are calibrated at any time after the first robot is installed.

Referring to FIG. 2 to FIG. 4, in step 101, a reference coordinate system 72 is generated by measurement of the three-dimensional measuring device 8 at a predetermined first state after installation of a first robot 1. The first state can be a state when the robot is driven with high accuracy with respect to the command value. The three-dimensional measuring device 8 is arranged at any region where the robot 1 is arranged and the position of the reflector 67a is measured. The reference coordinate system setting unit 53 generates the reference coordinate system 72 with the coordinate value in the measuring device coordinate system 73.

In step 102, the processing unit 51 drives the robot 1 with the command values of a predetermined operation program. The command value of the position and orientation of the robot in the operation program are specified by the coordinate value in the base coordinate system 71. For example, the robot 1 is driven by the command value of the operation program for performing calibration. In the example illustrated in FIG. 2, the reflector 67b is arranged at one measurement point 76 by driving the robot 1 with one command value. When the robot 1 stops, the position calculating unit 83 of the three-dimensional measuring device 8 calculates the position of the reflector 67b in the measuring device coordinate system 73. The position acquisition unit 52 converts the coordinate value of the position of the reflector 67b in the measuring device coordinate system 73 into the coordinate value of the position in the reference coordinate system 72. In this example, the position of the reflector 67b corresponds to the position of the robot. Thus, the position acquisition unit 52 acquires the coordinate value of the position of the robot in the reference coordinate system 72 based on the output of the three-dimensional measuring device 8.

The processing unit 51 repeats the control for acquiring the position of the robot with respect to the command value. The processing unit 51 drives the robot 1 with a plurality of command values. When the reflector 67b is arranged at each measurement point 76, the position acquisition unit 52 acquires the coordinate value of the position of the robot in the reference coordinate system 72. The storage part 42 stores a plurality of command values, and the coordinate values of a plurality of positions of the robots in the reference coordinate system corresponding to the plurality of command values. In order to accurately measure the mechanism error parameters, it is preferable to measure at, for example, dozens of measurement points 76.

Next, in step 103, the first robot 1 is replaced by a second robot 3. In the present embodiment, replacement to a robot with the same manufacturer and model number is performed. At this time, it is preferable to install the second robot so that the position on the installation surface and inclination to the installation surface of the second robot are as similar as possible to the position and inclination of the first robot.

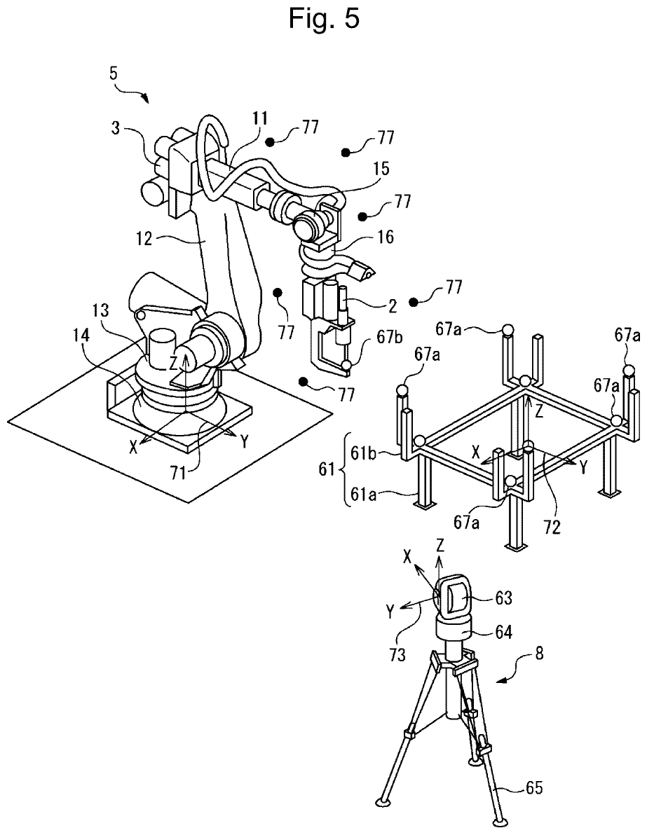

FIG. 5 illustrates a perspective view of the robot apparatus, the three-dimensional measuring device, and the auxiliary member, when a new robot is installed. In place of the first robot 1, the second robot 3 is installed at the floor. Preferably, the robot 3 is installed at the same position and inclination as the robot 1. However, due to production errors and individual differences in robot production, the reached position may deviate from the command value of the operation program. For this reason, calibration of the mechanism error parameters of the second robot 3 is performed.

Referring to FIG. 4 and FIG. 5, in step 104, after the second robot 3 is installed, the reference coordinate system setting unit 53 generates the reference coordinate system 72 using the output of the three-dimensional measuring device 8. In this example, the position of the three-dimensional measuring device 8 is different from the position illustrated in FIG. 2. However, by measuring the positions of a plurality of predetermined reflectors 67a, a reference coordinate system 72 with the same position and orientation with respect to a plurality of reflectors 67a can be reproduced. In other words, a reference coordinate system with the same position and orientation as the reference coordinate system used for the first robot 1 can be restored.

Next, in step 105, the processing unit 51 drives the second robot 3 with the same command value as the command value of the operation program used for the first robot 1. By driving the robot 3 with a plurality of command values, the reflector 67b moves to a measurement point 77. The position of the measurement point 77 may deviate from the position of the measurement point 76 of the first robot 1 in FIG. 2. When the reflector 67b is arranged at each measurement point 77, the position acquisition unit 52 acquires the coordinate value of the measurement point 77 in the reference coordinate system as the position of the robot 3 using the output of the three-dimensional measuring device 8. In other words, in driving the second robot 3 with the same predetermined command value as the first robot 1, the position acquisition unit 52 acquires the position of the reflector 67b in the reference coordinate system 72.

In step 106, the parameter calculating unit 54 calculates the mechanism error parameters of the second robot 3. The parameter calculating unit 54 calculates the mechanism error parameters of the second robot 3 so that the position of the robot in the reference coordinate system 72 of the second robot 3 (the position of the measurement point 77) matches the position of the robot in the reference coordinate system 72 of the first robot 1 (the position of the measurement point 76). In other words, when the second robot 3 is driven with the same command value as the first robot 1, the mechanism error parameters of the second robot 3 are calculated so that the tool center point reaches the same position.

The parameter calculating unit 54 can set the mechanism error parameters by the least squares method so that, for example, when the robot is driven with a plurality of command values, the error in the position of the second robot 3 with respect to the position of the first robot 1 becomes small. The parameter calculating unit 54 can calculate a plurality of constants included in the mechanism error parameters. Alternatively, the parameter calculating unit 54 may randomly change the variables included in the mechanism error parameters and may adopt variables that decrease the difference between the position of the second robot 3 and the position of the first robot 1 for the same command value.

The processing unit 51 can cause the storage part 42 to store the new mechanism error parameters calculated by the parameter calculating unit 54. When spot welding is performed by the second robot 3, the robot 3 can be controlled by using new mechanism error parameters. As a result, the second robot 3 can be controlled so as to be at almost the same position and orientation as the first robot 1 without performing the teaching work again for the second robot 3.

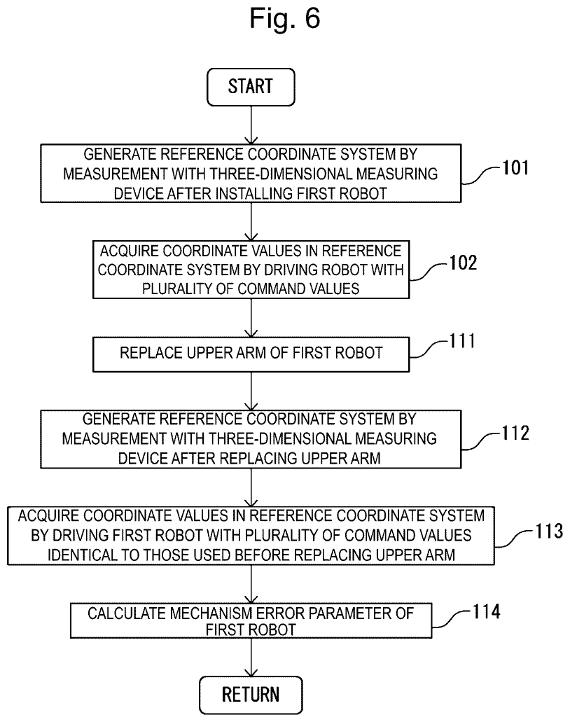

FIG. 6 illustrates a flowchart of a second control for calibrating the mechanism error parameters in the present embodiment. In the second control, the mechanism error parameters are calibrated when some components of the robot are replaced. When a robot is used, some components of the robot may fail. For example, a gear of a reduction gear may wear out over time. Alternatively, the strength of an arm may be reduced, and the deflection amount of the arm may increase. In such cases, calibration of the mechanism error parameters is performed after the some components of the robot are replaced.

In the second control, a first state is the state before the some components of the robot are replaced. A second state is a state after the some components of the robot are replaced. In particular, the second state is a state when some of the components of the robot deteriorate. In this regard, the case of replacing the upper arm among the components of the robot will be described as an example. Components to be replaced are not limited to the upper arm, but examples of the components may include a wrist, a rotational position detector, a motor, or a reduction gear.

In the second control, steps 101 and 102 are the same as in the first control (see FIG. 4). The first robot 1 is driven by a plurality of command values, and the position of the robot in the reference coordinate system 72 is stored. Next, in step 111, the upper arm 11 of the first robot 1 is replaced. Then, in step 112, the reference coordinate system setting unit 53 reproduces the reference coordinate system 72 by the output of the three-dimensional measuring device 8, after the replacement of the upper arm 11.

Next, in step 113, the processing unit 51 drives the first robot 1 with the same command values as before the replacement of the upper arm 11. The position acquisition unit 52 acquires the position of the reflector 67b in the reference coordinate system 72. In other words, the position acquisition unit 52 acquires the position of the first robot 1 with a new upper arm.

Next, in step 114, the parameter calculating unit 54 calculates the mechanism error parameters of the first robot 1. At this time, as in the first control, the parameter calculating unit 54 calculates the mechanism error parameters so that the position of the robot in the reference coordinate system 72 after the replacement of the upper arm 11 matches the position of the robot in the reference coordinate system 72 before the replacement of the upper arm 11. In other words, when the robot is driven with the same command value, the mechanism error parameters are calculated so that the tool center point of the robot reaches the same position.

Thus, the same calibration control can be performed when the entire robot is replaced and when some components of the robot are replaced. The calibration apparatus in the present embodiment can easily calibrate the mechanism error parameter so that the change in the position reached by the robot is small even after the robot or the components of the robot are replaced.

In particular, when the entire robot is replaced, errors in the position or inclination of the robot installation occur due to the inclination of the surface at which the robot is installed. However, by correcting the mechanism error parameters, the position reached by the robot after the replacement can be easily brought closer to the position reached by the robot before the replacement.

By performing the first control and the second control, a change in the position reached by the tool center point of the robot can be suppressed in one operation program. For this reason, the same operation program can be used after replacing the component or the robot. In other words, the same operation program can be used after the entire robot is replaced or after the components of the robot are replaced, without again performing the teaching work for teaching the position of the robot in the operation program.

Next, the third control in the calibration apparatus in the present embodiment is described. In the third control, the mechanism error parameters are calibrated after the entire robot is replaced. Before replacing the robot, the relationship between the command value (the position of the robot in the base coordinate system) and the position of the robot in the reference coordinate system, can be calculated. In other words, the relationship of the relative position and orientation between the base coordinate system and the reference coordinate system, can be calculated. In the third control, the mechanism error parameters are calibrated in the second state by using the transformation matrix of the reference coordinate system 72 as seen from the base coordinate system 71 in the first state.

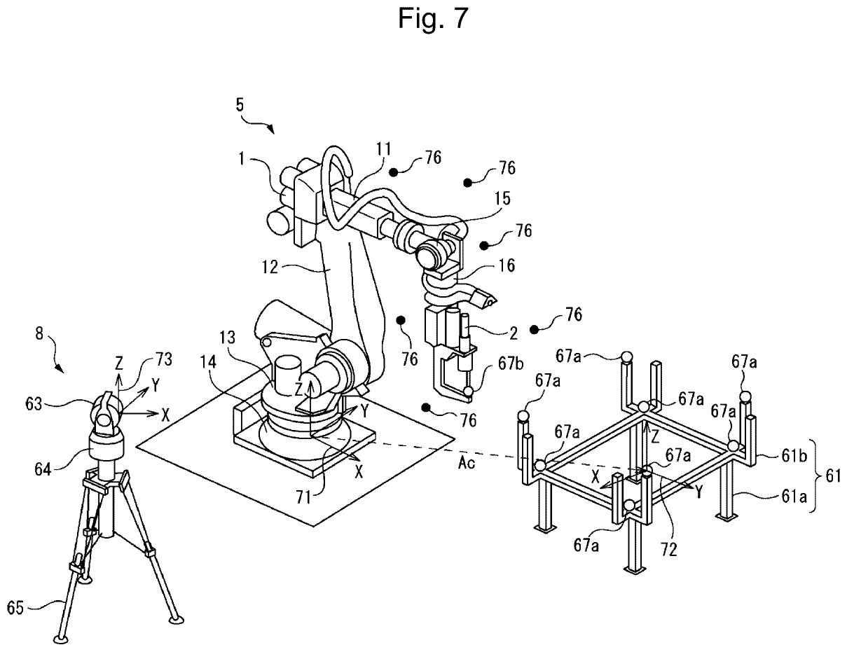

FIG. 7 illustrates a perspective view when the coordinate values of the position of the robot are measured with a three-dimensional measuring device. In the first state, the processing unit 51 drives the robot 1 based on a predetermined command value. The position acquisition unit 52 acquires the position of each measurement point 76 corresponding to the position of the robot 1, in the reference coordinate system 72. In order to calculate an accurate transformation matrix, it is preferable to measure at, for example, dozens of measurement points 76.

In this regard, the position of each measurement point 76 is assumed to be at a coordinate value P₀ in the reference coordinate system 72. The matrix of the reference coordinate system 72 as seen from the base coordinate system 71 is assumed to be a transformation matrix Ac. An inverse matrix Ac⁻¹ of the transformation matrix Ac is a matrix that converts the coordinate value of the base coordinate system 71 into the coordinate value of the reference coordinate system 72. Further, when the measurement point 76 in the base coordinate system 71, that is, the position of the robot for the command value is a coordinate value P₁, the following equation (1) holds.

$${P}_{0} = {Ac}^{- 1} {P}_{1} \qquad ( 1 )$$

Referring to FIG. 3 and FIG. 7, the matrix calculating unit 55 of the processing unit 51 acquires the coordinate value P₁ of the command value expressed in the base coordinate system 71. When the robot 1 is driven based on the command value, the matrix calculating unit 55 acquires the coordinate value P₀ in the reference coordinate system 72 of each measurement point 76 from the position acquisition unit 52. The matrix calculating unit 55 calculates the transformation matrix Ac based on the coordinate value P₀ of the position of each measurement point 76 in the reference coordinate system, and the coordinate value P₁ of the command value. For example, when the coordinate value in the reference coordinate system 72 is calculated from the coordinate value P₁ by using the transformation matrix Ac, the transformation matrix Ac can be calculated by the least squares method so that the error (distance) between this coordinate value and the coordinate value P₀ is minimized. Alternatively, when the coordinate value P₀ in the reference coordinate system 72 is converted into the coordinate value in the base coordinate system by using the transformation matrix Ac, the transformation matrix Ac can be calculated by the least squares method so that the error (distance) between this coordinate value and the command value of the robot is minimized.

The transformation matrix Ac, for example, can be 4 rows×4 columns homogeneous transformation matrix. In other words, a matrix including the rotation and translation of the coordinate system can be adopted. The storage part 42 stores the calculated transformation matrix Ac. Thus, the processing unit 51 can calculate the transformation matrix Ac in the first state.

The present embodiment calculates a transformation matrix that converts the coordinate value of the base coordinate system 71 into the coordinate value of the reference coordinate system 72, but is not limited to this form. The matrix calculating unit may calculate a transformation matrix that converts the coordinate value of the reference coordinate system into the coordinate value of the base coordinate system. By using this matrix, the coordinate value of the reference coordinate system can also be converted into the coordinate value of the base coordinate system, or the coordinate value of the base coordinate system can be converted into the coordinate value of the reference coordinate system.

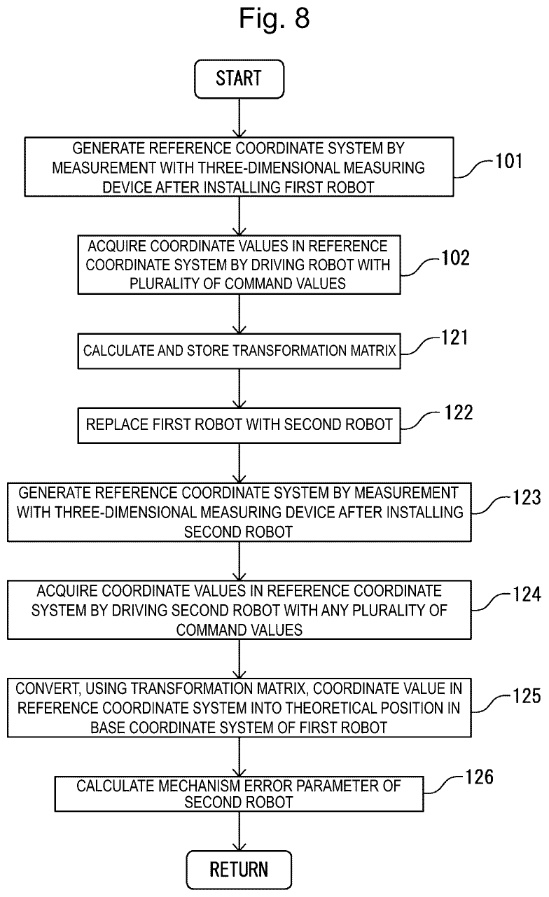

FIG. 8 illustrates a flowchart of the third control for calibration of the mechanism error parameter in the present embodiment. With reference to FIG. 3, FIG. 7, and FIG. 8, steps 101 and 102 are the same as in the first control in the present embodiment (see FIG. 4). The coordinate value of the measurement point 76 in the reference coordinate system 72 (position of the robot 1) is acquired by driving the first robot 1 with a plurality of command values before replacing the robot 1. In the first state, the position acquisition unit 52 acquires a plurality of positions of the robot in the reference coordinate system 72 when the robot 1 is driven based on the plurality of command values of the robot 1.

Next, in step 121, the matrix calculating unit 55 calculates, in the first state, the transformation matrix Ac based on a plurality of command values of the first robot 1 and a plurality of positions of the first robot 1 in the reference coordinate system 72. The storage part 42 stores the transformation matrix Ac. Then, in step 122, the first robot is replaced with the second robot. The robot apparatus 5 enters the second state.

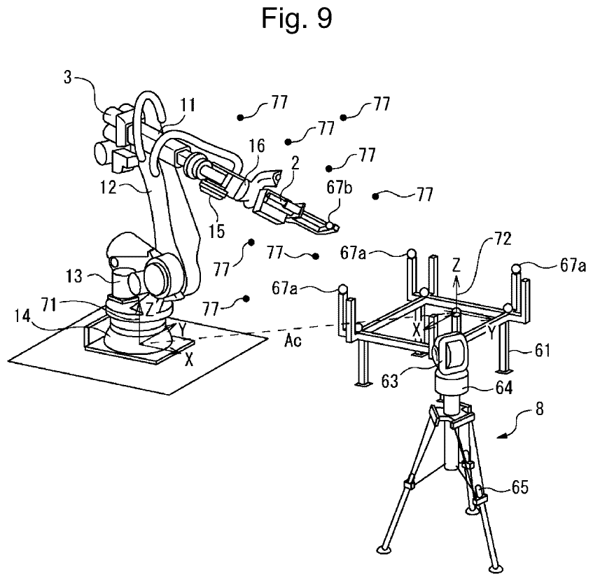

FIG. 9 illustrates a perspective view of the robot, the three-dimensional measuring device, and the auxiliary member, after replacing the first robot with the second robot. Referring to FIG. 3, FIG. 8, and FIG. 9, in step 123, after installing the second robot 3, the reference coordinate system setting unit 53 reproduces the reference coordinate system 72 based on the output of the three-dimensional measuring device 8.

In step 124, the second robot 3 is driven with a plurality of command values. The command values indicated in the base coordinate system 71 at this time may be different from the command values when the first robot 1 is driven. The second robot 3 can be driven with any plurality of command values. FIG. 9 illustrates the measurement points 77 reached by the tool center point when the second robot 3 is driven with a plurality of command values. In order to calculate accurate mechanism error parameter, it is preferable to measure at, for example, dozens of measurement points 77.

At each position of the robot 3, the position calculating unit 83 of the three-dimensional measuring device 8 detects the position of each measurement point 77 using the coordinate value of the measuring device coordinate system 73. The position acquisition unit 52 converts the coordinate value of the position of the measurement point 77 calculated in the measuring device coordinate system 73 into the coordinate value P₀ of the measurement point 77 in the reference coordinate system 72. In other words, the position acquisition unit 52 acquires a plurality of positions of the robot in the reference coordinate system 72.

Next, in step 125, the parameter calculating unit 54 converts the coordinate value of the measurement point 77 in the reference coordinate system 72 into the coordinate value in the base coordinate system 71 of the first robot 1 by using the transformation matrix Ac. In other words, the theoretical position of the robot in the base coordinate system 71 of the first robot 1 is calculated from the position of the second robot based on the reference coordinate system 72 by using the above equation (1).

Next, in step 126, the parameter calculating unit 54 calculates the mechanism error parameter of the second robot 3. The parameter calculating unit 54 acquires the command value of the second robot 3. The parameter calculating unit 54 calculates the mechanism error parameter so that the command value of the second robot 3 matches the coordinate value of the theoretical position of the robot in the base coordinate system 71 of the first robot 1. This control allows the parameter calculating unit 54 to calculate the mechanism error parameters so that the position in the reference coordinate system reached by the second robot 3 matches the position in the reference coordinate system reached by the first robot 1. For example, the parameter calculating unit 54 calculates the mechanism error parameter by the least squares method so that the error (distance) between the command value of the second robot 3 and the coordinate value of the theoretical position in the base coordinate system of the first robot 1 is minimized.

Thus, in the third control, the transformation matrix Ac acquired in the first state can be stored. In the second state, by using the transformation matrix Ac, the position of the robot in the reference coordinate system can be converted into the theoretical position of the base coordinate system in the first state. Then, the mechanism error parameter can be calculated so that the position reached by the command value of the second robot matches the theoretical position. Alternatively, in the second state, the command value of the second robot can be converted into the theoretical position of the robot in the reference coordinate system by using the transformation matrix Ac. Then, the mechanism error parameters may be calculated so that this theoretical position matches the position in the reference coordinate system reached by the second robot (the position acquired by the position acquisition unit 52).

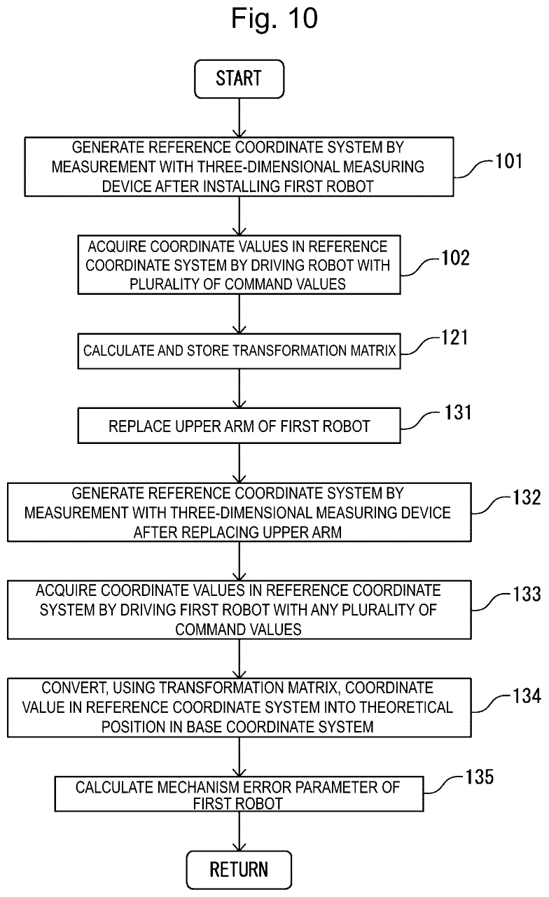

FIG. 10 illustrates a flowchart of the fourth control for calibrating the mechanism error parameters of the robot. In the fourth control, the mechanism error parameters are calibrated after replacing some components of the robot. In this case, an example of replacing the upper arm of the robot 1 will be described. In the fourth control, as in the third control, the transformation matrix Ac is calculated in advance in the first state. Then, in the second state, the mechanism error parameters are calibrated based on the transformation matrix Ac.

Steps 101, and 102, and step 121 are the same as in the third control of the present embodiment (see FIG. 8). Next, in step 131, the upper arm 11 of the first robot 1 is replaced.

In step 132, the reference coordinate system setting unit 53 reproduces the reference coordinate system 72 based on the measurement results of the three-dimensional measuring device 8 after replacing the upper arm 11. In step 133, the processing unit 51 drives the first robot 1 with any plurality of command values. Based on the output of the three-dimensional measuring device 8, the position acquisition unit 52 acquires the coordinate values of the measurement points 77 in the reference coordinate system 72 (the position of the robot 1).

In step 134, the parameter calculating unit 54 converts the coordinate values of the measurement points 77 in the reference coordinate system into the theoretical position in the base coordinate system 71 of the first robot 1 by using the transformation matrix Ac. In this example, since the upper arm is replaced, the position and orientation of the origin of the base coordinate system 71 set to the base part 14 does not change.

In step 135, the parameter calculating unit 54 calculates the mechanism error parameters of the first robot 1. The parameter calculating unit 54 calculates the mechanism error parameter so that the command value of the robot in the base coordinate system 71 matches the coordinate value of the theoretical position of the robot in the base coordinate system 71 of the first robot 1. Thus, in the fourth control, the mechanism error parameter can be calibrated by the same control as in the third control when some components of the robot are replaced.

When the robot apparatus is driven for a long period of time, the components of the robot deteriorate or gradually deform. The position at which the tool center point of the robot reaches may deviate from the command of the operation program, may be deviated. In this case, the same control as the second control or the fourth control in the present embodiment can be performed. At any time the robot is being driven, the robot can be calibrated by performing the same control as the second control or the fourth control without replacing the components. For example, in the fourth control, the control of calibration from step 112 to step 114 in FIG. 6 can be performed without replacing the upper arm in step 111. Such robot calibration can be performed, for example, at predetermined time intervals.

In this case, the first state that is the reference state of the robot is, for example, the state immediately after installing the robot. The second state of the robot is the state in which at least some components of the robot have deteriorated due to using the robot.

Referring to FIG. 3, the controller 4 in the present embodiment functions as a determination apparatus for determining the need for calibrating the mechanism error parameter. The processing unit 51 in the present embodiment is provided with the maintenance determination unit 56 that evaluates the accuracy of the position of the robot 1 with respect to the command value of the operation program 46. The maintenance determination unit 56 determines the need for calibrating the mechanism error parameters based on the position of the robot in the reference coordinate system 72 in the first state and the position of the robot in the current reference coordinate system 72.

In particular, the maintenance determination unit 56 of the processing unit 51 functions as a determination apparatus. The maintenance determination unit 56 evaluates the accuracy of the position reached by the robot by using the transformation matrix Ac calculated by the third control and fourth control in the present embodiment.

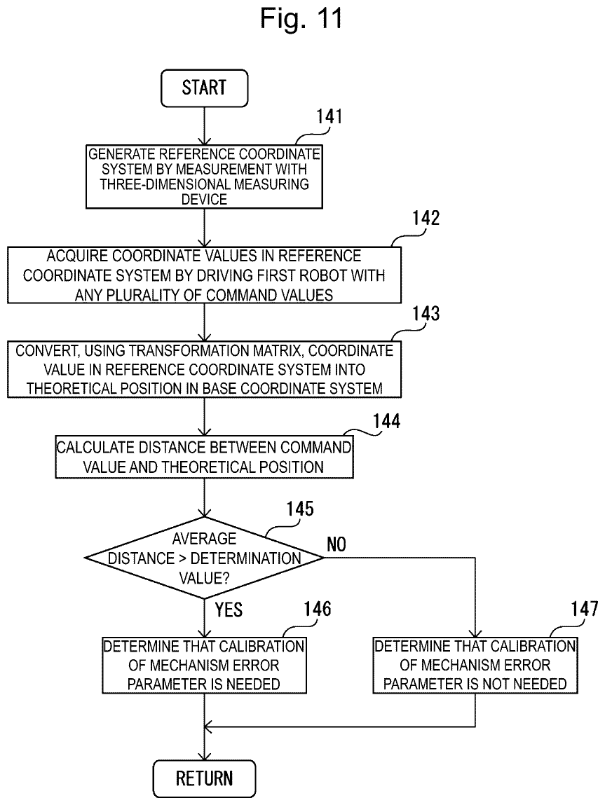

FIG. 11 illustrates a flowchart of the fifth control by the maintenance determination unit of the present embodiment. Referring to FIG. 8, first, the processing unit 51 performs steps 101 and 102, and step 121 in the third control of the present embodiment and calculates the transformation matrix Ac. The storage part 42 stores the transformation matrix Ac (refer to FIG. 8). The control for calculating the transformation matrix Ac is preferably performed immediately after the robot is installed and after the mechanism error parameters are calibrated, for example.

Next, the control from step 141 to step 143 is the same as the control from step 132 to step 134 in the fourth control. In step 141, the reference coordinate system setting unit 53 generates the reference coordinate system 72 based on measurements of the three-dimensional measuring device 8 at any time. In step 142, the processing unit 51 drives the first robot with any plurality of command values. The position acquisition unit 52 acquires the coordinate value of the position of the robot in the reference coordinate system 72. In step 143, the parameter calculating unit 54 converts the coordinate value of the position of the robot in the reference coordinate system 72 into the coordinate value in the base coordinate system 71 of the robot by using the transformation matrix Ac. The parameter calculating unit 54 converts a plurality of positions of the robot in the reference coordinate system into the theoretical positions.

In step 144, the maintenance determination unit 56 calculates a distance between the predetermined robot command value and the theoretical position in the base coordinate system. For example, the maintenance determination unit 56 calculates a distance between the coordinate value in the command value of the robot in the operation program, and the coordinate value in the theoretical position. The maintenance determination unit 56 calculates the distance for each combination of a plurality of command values and theoretical positions.

In step 145, the maintenance determination unit 56 calculates the average of the plurality of distances. The maintenance determination unit 56 determines whether or not the average value of the distance exceeds a predetermined determination value. When the average value of the distance exceeds the determination value, the control moves to step 146.

In step 146, the maintenance determination unit 56 determines that the mechanism error parameters need to be calibrated. In the present embodiment, the display part 39 of the teach pendant 37 indicates that the mechanism error parameters need to be calibrated.

In step 145, when the average value of the distance is less than or equal to the determination value, the control moves to step 147. In step 147, the maintenance determination unit 56 determines that the calibration of the mechanism error parameters is not needed. Then, the display part 39 indicates that the calibration of the mechanism error parameters is not needed.

In the present embodiment, the maintenance determination unit 56 performs the determination based on the average value of the distance between the command value of the robot and the theoretical position converted into the base coordinate system, but is not limited to this configuration. Any control can be used for determination whether or not the command value of the robot is far from the theoretical position. For example, when the maximum value of the distance among a plurality of distances corresponding to a plurality of command values is greater than the determination value, it may be determined that calibration is necessary.

At each predetermined period, the maintenance determination unit 56 can determine whether or not the accuracy of the position of the robot deviates from the predetermined determination range. The maintenance determination unit 56 can determine that calibration of the mechanism error parameter is required when the accuracy of the robot deviates from a predetermined determination range. For example, a determination can be made whether or not to calibrate the mechanism error parameters for each predetermined length of driving time of the robot or predetermined length of time since the robot is installed.

In addition, the maintenance determination unit 56 can determine that the calibration of the mechanism error parameter is needed when detecting the replacement of components constituting the robot. For example, when an operator inputs information that some components of the robot has been replaced, on the input part 38 of the teach pendant 37, the maintenance determination unit 56 determines that the mechanism error parameters need to be calibrated. Alternatively, the maintenance determination unit 56 may determine that calibration of the mechanism error parameter is needed when detecting the replacement of the robot. The display part 39 can then indicate to the operator that the mechanism error parameters need to be calibrated. The operator may perform one or more of the aforementioned first control to fourth control when the calibration of the mechanism error parameters is performed.

In the above embodiment, the controller of the robot functions as a calibration apparatus and a determination apparatus, but is not limited to this configuration. An arithmetic processing device acting as a calibration apparatus or an arithmetic processing device acting as a determination apparatus may be connected to the controller of the robot by a communication device.

In the present embodiment, the reference coordinate system is set by using the laser tracker and the auxiliary member, but is not limited to this configuration. With any device and control, a reference coordinate system can be set in the three-dimensional space. For example, by using a three-dimensional vision sensor, the position of an immovable characteristic part as a reference point may be detected, and a reference coordinate system may be set based on the position of the characteristic part. The three-dimensional vision sensor may also detect the characteristic part of the robot and detect the position and orientation of the robot. Additionally, the calibration apparatus may not include a three-dimensional measuring device. The calibration apparatus may be configured to acquire and process data of the three-dimensional measuring device acquired outside the calibration apparatus.

In above described each control, the order of steps can be changed appropriately to the extent that the function and action are not changed.

The above embodiments can be combined as appropriate. In each of the above-described drawings, the same or equivalent parts are denoted by the same sign. The above embodiments are examples and do not limit the invention. In addition, the embodiments include the modifications of the embodiments defined in the claims.

1. A calibration apparatus configured to calibrate a mechanism error parameter for adjusting control of a robot based on an operation program, the calibration apparatus comprising:
a position acquisition unit configured to acquire a position of a robot in a reference coordinate system; and
a parameter calculating unit configured to calculate a mechanism error parameter based on the position of the robot in the reference coordinate system, wherein
the parameter calculating unit is configured to calculate the mechanism error parameter so that a position of the robot in the reference coordinate system in a second state after a first state matches a position of the robot in the reference coordinate system in the first state, when the robot is driven by a command value of an operation program.

2. The calibration apparatus of claim 1, wherein the reference coordinate system is an immovable coordinate system defined so as not to depend on an operation of the robot and an installation state of the robot.

3. The calibration apparatus of claim 1, comprising a matrix calculating unit configured to calculate a transformation matrix by which one coordinate value among a coordinate value of a base coordinate system set for the robot and a coordinate value of the reference coordinate system is converted into the other coordinate value, wherein
the operation program includes a command value of the robot, the command value being specified by the coordinate value of the base coordinate system,
the position acquisition unit is configured to acquire, in the first state, a plurality of positions of the robot in the reference coordinate system when the robot is driven based on a plurality of command values of the robot,
the matrix calculating unit is configured to calculate the transformation matrix, in the first state, based on the plurality of command values of the robot and the plurality of positions of the robot in the reference coordinate system,
the position acquisition unit is configured to acquire a plurality of positions of the robot in the reference coordinate system when the robot is driven based on the plurality of command values of the robot, in the second state, and
the parameter calculating unit is configured to calculate a theoretical position of the robot in the base coordinate system based on the position of the robot in the reference coordinate system and the transformation matrix when the robot is driven by each of the plurality of command values in the second state, and calculate the mechanism error parameter so that the command value of the robot matches the theoretical position of the robot in the base coordinate system.

4. The calibration apparatus of claim 3, wherein the matrix calculating unit is configured to calculate the transformation matrix so as to minimize a distance between the command value of the robot in the base coordinate system and the theoretical position of the robot in the base coordinate system, which is calculated by the transformation matrix from the position of the robot in the reference coordinate system, in the first state.

5. The calibration apparatus of claim 1, comprising a maintenance determination unit configured to evaluate accuracy of a position of the robot with respect to a command value of the operation program, wherein
the maintenance determination unit is configured to determine a need for a calibrating the mechanism error parameter, based on the position of the robot in the reference coordinate system in the first state and a present position of the robot in the reference coordinate system, when the robot is driven with a command value of a predetermined operation program.

6. The calibration apparatus of claim 5, wherein the maintenance determination unit is configured to determine whether or not the accuracy of the position of the robot deviates from a predetermined determination range per predetermined period, and determine that calibration of the mechanism error parameter is needed, when the accuracy of the position of the robot deviates from the predetermined determination range.

7. The calibration apparatus of claim 5, wherein the maintenance determination unit is configured to determine that calibration of the mechanism error parameter is needed when replacement of components constituting the robot is detected.

8. The calibration apparatus of claim 5, wherein the maintenance determination unit is configured to determine that calibration of the mechanism error parameter is needed, when replacement of the robot is detected.

9. The calibration apparatus of claim 1, wherein the first state is a reference state of the robot before calibration of the mechanism error parameter is performed.

10. The calibration apparatus of claim 9, wherein the first state is a state immediately after the robot is installed, and
the second state is a state when at least some components of the robot deteriorate by using the robot.

11. The calibration apparatus of claim 9, wherein the first state is a state before the robot is replaced and
the second state is a state after replacement of the robot, in which a new robot is installed.

12. The calibration apparatus of claim 9, wherein the first state is a state before some components of the robot are replaced, and
the second state is a state after some components of the robot are replaced.

13. The calibration apparatus of claim 1, comprising:
a plurality of members acting as reference points and installed at a region where the robot is installed;
a three-dimensional measuring device configured to measure the positions of the reference points; and
a reference coordinate system setting unit configured to set the reference coordinate system in a three-dimensional space, based on the positions of the reference points measured by the three-dimensional measuring device.

14. A determination apparatus configured to determine a need for calibrating a mechanism error parameter for adjusting control of a robot based on an operation program, the determination apparatus comprising:
a position acquisition unit configured to acquire a position of the robot in a reference coordinate system; and
a maintenance determination unit configured to evaluate accuracy of the position of the robot with respect to a command value of the operation program, wherein
the maintenance determination unit is configured to determine a need for a calibrating the mechanism error parameter, based on a position of the robot in the reference coordinate system in a first state and a present position of the robot in the reference coordinate system, when the robot is driven by the command value of the operation program.
